(19) United States
(12) Patent Application Publication
(10) Pub. No.: US 2009/0193402 A1
(43) Pub. Date: Jul. 30, 2009

(54) Iterative Compilation Supporting Entity Instance-Specific Compiler Option Variations

(76) Inventors: Guy Bashkansky, Haifa (IL); Gad Haber, Nesher (IL); Yaakov Yaari, Haifa (IL); Marcel Zalmanovici, Kiriat Motzkin (IL)

Correspondence Address: IBM CORPORATION, T.J. WATSON RESEARCH CENTER, P.O. BOX 218, YORKTOWN HEIGHTS, NY, 10598, US

(21) Appl. No.: 12/020,586

(22) Filed: Jan. 28, 2008

(51) Int. Cl. G06F 9/45

(52) U.S. Cl. 717/145; 717/151

(57) ABSTRACT

Optimizing a computer program by setting a first compiler optimization configuration for a first entity of a computer program, setting a second compiler optimization configuration for a second entity of the computer program, where the first and second entities are of the same type and where the first and second compiler optimization configurations differ, and compiling the computer program in accordance with the compiler optimization configurations, thereby creating a compiled program.

### FIELD OF THE INVENTION

The present invention relates to computer program compilers in general, and more particularly to setting compiler options for iterative compilers.

### BACKGROUND OF THE INVENTION

Improving the optimization potential of compilers is an important concern in computer science and computer engineering today. Most compilers and other program optimization systems present the user with many optimization options, some of which are parameterized. However, as each computer program is different, applying a set of optimization options to one program may improve the performance of the compiled program, whereas applying the same set of optimization options to another program may actually degrade the performance of the compiled program. Thus, a program typically benefits most from a customized set of optimization options.

In one current method for producing program-specific optimizations, a program is compiled multiple times, each time using a different set of optimization options. In this method, known as iterative compilation, the different sets of optimization options are typically automatically selected, with each compiled program version being evaluated to determine to what degree the selected optimization options resulted in an improvement. This allows the set to be iteratively tuned and used to compile the program until an optimal set is determined.

Current program optimization techniques allow for optimization options to be selected for a program as a whole, where an optimization option that is selected for a program is applied to all relevant program entities. Thus, as different sets of optimization options will either include a specific optimization option or not, where a maximum of n optimization options (including specific option/parameter value pairs) may be selected for a program, 2ⁿ different option sets may be tested for a given program. If more than 2ⁿ different option sets could be generated from a given pool of n optimization options, more program variants could be tested.

### SUMMARY OF THE INVENTION

The present invention in embodiments thereof discloses novel systems and methods for iterative compilation supporting entity instance-specific compiler option variations.

In one aspect of the present invention a method is provided for optimizing a computer program, the method including setting a first compiler optimization configuration for a first entity of a computer program, setting a second compiler optimization configuration for a second entity of a computer program, where the first and second entities are of the same type and where the first and second compiler optimization configurations differ, and compiling the computer program in accordance with the compiler optimization configurations, thereby creating a compiled program.

In another aspect of the present invention the method setting different compiler optimization configurations for any of the entities if a predefined termination condition is not met after performing the compiling step, and again compiling the computer program in accordance with the compiler optimization configurations, thereby creating another compiled version of the program.

In another aspect of the present invention the method further includes performing the setting and compiling steps a plurality of times until a predefined termination condition is met.

In another aspect of the present invention the method further includes determining a fitness level for the compiled program, where the predefined termination condition is met when a predefined fitness level is reached.

In another aspect of the present invention the predefined termination condition is met when the setting and compiling steps are performed a predefined number times.

In another aspect of the present invention the method further includes performing the setting and compiling steps a plurality of times until for any fitness value that is achieved, no better fitness value is achieved after a predefined number of subsequent iterations.

In another aspect of the present invention a system is provided for optimizing a computer program, the system including means for setting a first compiler optimization configuration for a first entity of a computer program, and for setting a second compiler optimization configuration for a second entity of a computer program, where the first and second entities are of the same type and where the first and second compiler optimization configurations differ, and a compiler configured to compile the computer program in accordance with the compiler optimization configurations.

In another aspect of the present invention the compiler includes the means for setting the optimization configurations.

In another aspect of the present invention the means for setting is configured to set different compiler optimization configurations for any of the entities if a predefined termination condition is not met after performing the compiling step, and the compiler is configured to again compile the computer program in accordance with the compiler optimization configurations.

In another aspect of the present invention the means for setting and the compiler are configured to perform the setting and the compiling a plurality of times until a predefined termination condition is met.

In another aspect of the present invention the system further includes means for determining a fitness level for the compiled program, where the predefined termination condition is met when a predefined fitness level is reached.

In another aspect of the present invention the predefined termination condition is met when the setting and compiling steps are performed a predefined number times.

In another aspect of the present invention the means for setting and the compiler are configured to perform the setting and the compiling a plurality of times until for any fitness value that is achieved, no better fitness value is achieved after a predefined number of subsequent iterations.

In another aspect of the present invention a computer program is provided embodied on a computer-readable medium, the computer program including a first code segment operative to set a first compiler optimization configuration for a first entity of a computer program, and a second compiler optimization configuration for a second entity of said computer program, where the first and second entities are of the same type and where the first and second compiler optimization configurations differ, and a second code segment operative to a compile said computer program in accordance with the compiler optimization configurations.

In another aspect of the present invention the first code segment is operative to set different compiler optimization configurations for any of the entities if a predefined termination condition is not met after performing the compiling step, and the second code segment is operative to again compile the computer program in accordance with the compiler optimization configurations.

In another aspect of the present invention the code segments are operative to perform the setting and the compiling a plurality of times until a predefined termination condition is met.

In another aspect of the present invention the computer program further includes a third code segment operative to determine a fitness level for the compiled program, where the predefined termination condition is met when a predefined fitness level is reached.

In another aspect of the present invention the predefined termination condition is met when the setting and compiling steps are performed a predefined number times.

In another aspect of the present invention the code segments are configured to perform the setting and the compiling a plurality of times until for any fitness value that is achieved, no better fitness value is achieved after a predefined number of subsequent iterations.

### BRIEF DESCRIPTION OF THE DRAWINGS

The present invention in embodiments thereof will be understood and appreciated more fully from the following detailed description taken in conjunction with the appended drawings in which:

FIG. 1 is a simplified illustration of a system for iterative compilation of computer programs, constructed and operative in accordance with an embodiment of the present invention;

FIG. 2A is an exemplary listing of program entities useful in understanding the present invention;

FIG. 2B is an exemplary listing of program entities and associated optimization options and parameters, constructed and operative in accordance with an embodiment of the present invention;

FIG. 3A is a simplified flowchart illustration of an exemplary method of operation of the system of FIG. 1, operative in accordance with an embodiment of the invention; and

FIG. 3B is an exemplary listing of program entities and selected optimization options and parameters, constructed and operative in accordance with an embodiment of the present invention.

### DETAILED DESCRIPTION OF THE INVENTION

The present invention is now described within the context of one or more embodiments, although the description is intended to be illustrative of the invention as a whole, and is not to be construed as limiting the invention to the embodiments shown. It is appreciated that various modifications may occur to those skilled in the art that, while not specifically shown herein, are nevertheless within the true spirit and scope of the invention.

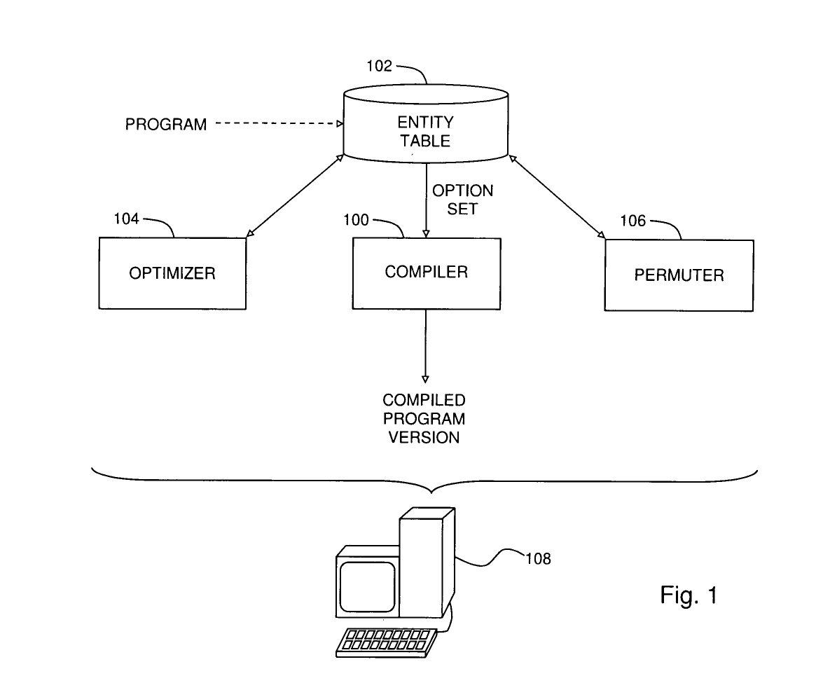

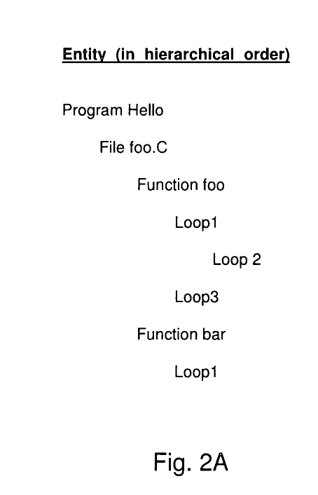

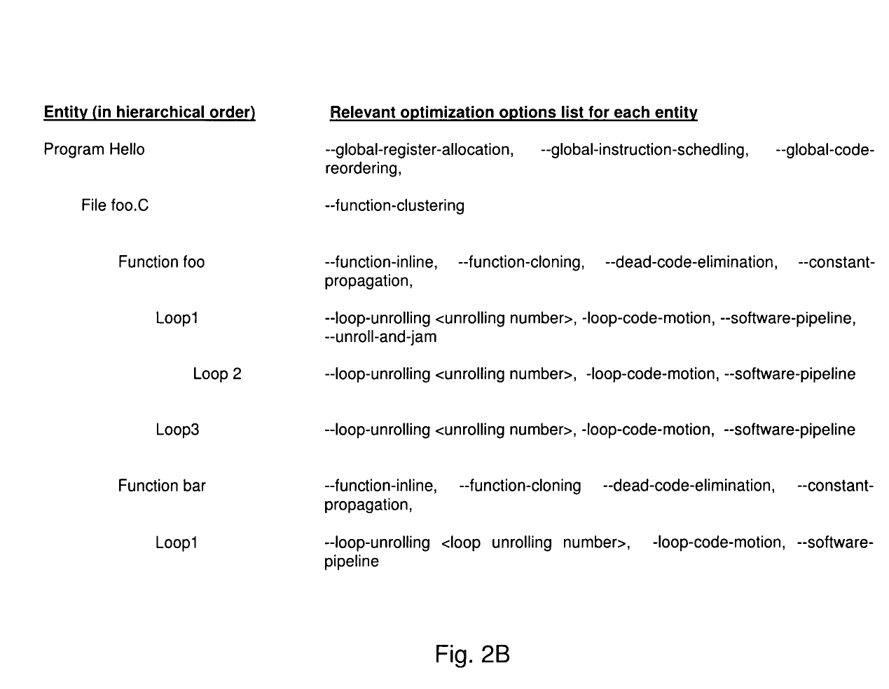

Reference is now made to FIG. 1 which is a simplified conceptual illustration of a system for iterative compilation of computer programs, constructed and operative in accordance with an embodiment of the present invention. In the system of FIG. 1, a computer program is provided to a compiler 100 for compiling. Prior to compiling the computer program, an entity table 102 is created from the computer program, by compiler 100 or otherwise using conventional techniques, listing individual program entities, such as loops and functions, and preferably the hierarchical relationships between them. An example of such a listing of program entities is shown in FIG. 2A. In accordance with the present invention, one or more compiler optimization options and parameters are associated with one or more of the program entities and included in entity table 102. The selection of the compiler optimization options and parameters are done manually, or automatically by an optimizer 104, which is separate from or incorporated into compiler 100, such as where compiler optimization options and parameters are predefined for one or more program entity types. For example, a “loop unrolling” compiler optimization option along with a “loop unrolling number” parameter may be predefined for use with a “loop” program entity. The automatic selection of the compiler optimization options and parameters are done in accordance with a predefined algorithm, such as a genetic algorithm or a random selection algorithm. An example of such a listing of program entities and associated compiler optimization options and parameters that may be selected for each entity is shown in FIG. 2B.

It will be appreciated that different compiler optimization options and parameters may be associated with different instances of the same program entity, such as where a “function cloning” optimization option is selected for one program function, while a “dead code elimination” optimization option is selected for another program function. These differences may be manually controlled, or automatically controlled in accordance with a predefined algorithm.

Once the compiler optimization options and parameters have been associated with the program entities, any values required for the indicated options and parameters are selected, either manually, or automatically by a permuter 106, which is separate from or incorporated into compiler 100 or optimizer 104, that selects such values in accordance with a predefined algorithm.

It will be appreciated that different compiler optimization option and parameter values may be associated with different instances of the same program entity having the same compiler optimization options and parameters, such as different loops within the same program having the same “loop unrolling” compiler optimization option, but having different “loop unrolling number” parameter values. These differences may likewise be manually controlled, or automatically controlled in accordance with a predefined algorithm.

The compiler optimization option, any associated parameter, and any associated value, that has been selected for a program entity is now referred to as the compiler optimization configuration for that entity.

Once the compiler optimization configurations have been set for all program entities that are to be optimized, compiler 100 preferably compiles the computer program in accordance with the selected compiler optimization configurations. The compiled program is then preferably evaluated using conventional techniques, such as by executing the compiled program and measuring predefined execution benchmarks, to arrive at a fitness value. The fitness value may be any known fitness value, such as, for example, a running time, a throughput rate, and/or a memory footprint.

The above process of selecting values for the selected compiler optimization options and parameters, and optionally of selecting the compiler optimization options and parameters themselves, compiling the program in accordance with its compiler optimization configurations, and evaluating the compiled program, is performed one or more times with different compiler optimization configurations each time until the process is manually terminated or until a predefined termination condition are met, such as when a predefined number of iterations is reached, or when a predefined fitness value is achieved, or when for any given fitness value that is achieved, no better fitness value is achieved after a predefined number of subsequent iterations.

Any of the elements shown in FIG. 1 are preferably executed by or otherwise accessible to a computer 108.

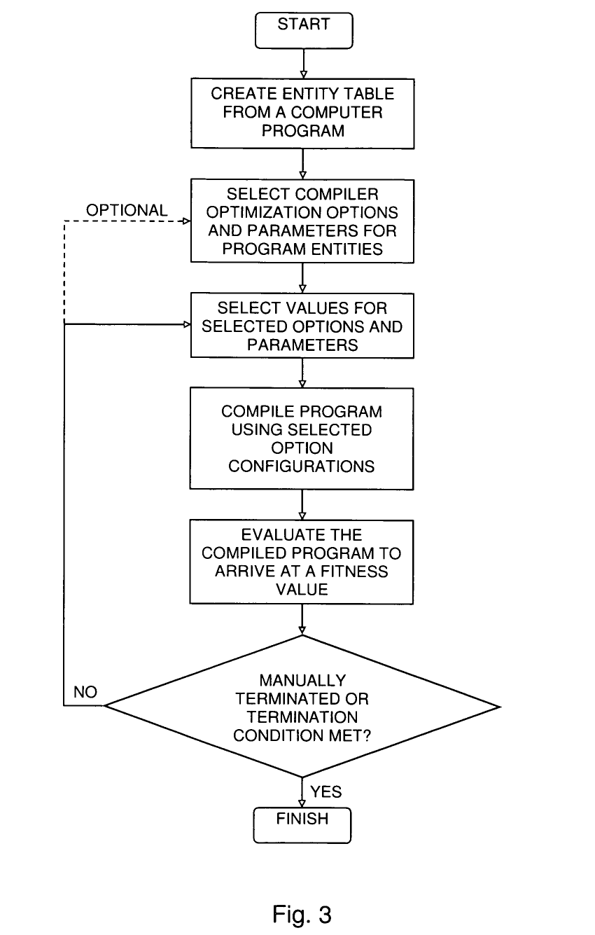

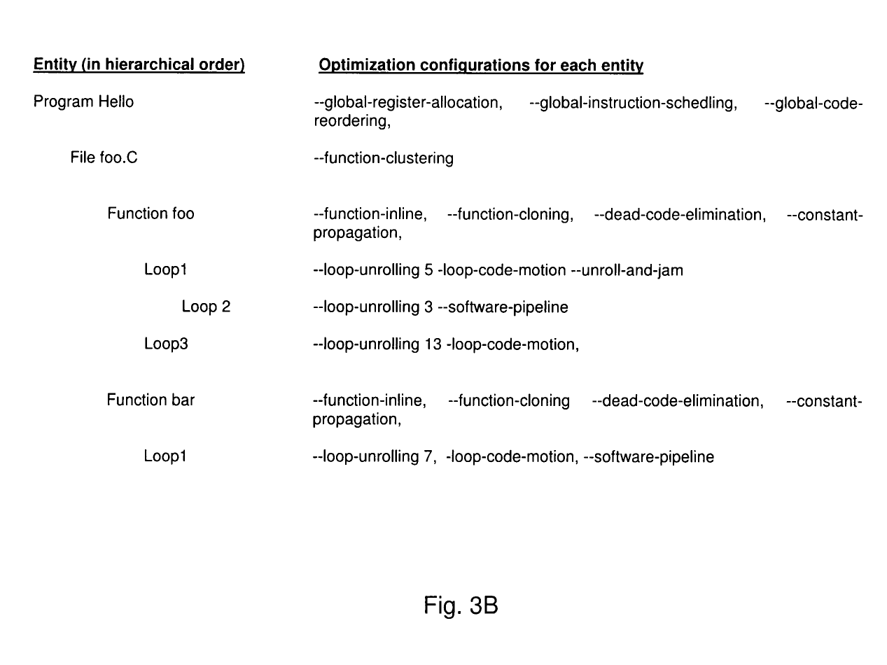

Reference is now made to FIG. 3A which is a simplified flowchart illustration of an exemplary method of operation of the system of FIG. 1, operative in accordance with an embodiment of the invention. In the method of FIG. 3A, an entity table is created from a computer program listing individual program entities. One or more compiler optimization options and parameters are associated with one or more of the program entities and included in the entity table. Any values required for the indicated options and parameters are then selected. An example of such a listing of program entities and their compiler optimization configurations is shown in FIG. 3B. The computer program is then compiled in accordance with its compiler optimization configurations. The compiled program is then evaluated to arrive at a fitness value. These steps, starting either with selecting values for the selected compiler optimization options and parameters, or with selecting the compiler optimization options and parameters themselves, are performed one or more times until the process is manually terminated or until a predefined termination condition is met.

It is appreciated that one or more of the steps of any of the methods described herein may be omitted or carried out in a different order than that shown, without departing from the true spirit and scope of the invention.

While the methods and apparatus disclosed herein may or may not have been described with reference to specific computer hardware or software, it is appreciated that the methods and apparatus described herein may be readily implemented in computer hardware or software using conventional techniques.

What is claimed is:

1. A method for optimizing a computer program, the method comprising:
setting a first compiler optimization configuration for a first entity of a computer program;
setting a second compiler optimization configuration for a second entity of said computer program, wherein said first and second entities are of the same type and wherein said first and second compiler optimization configurations differ; and
compiling said computer program in accordance with said compiler optimization configurations, thereby creating a compiled program.

2. A method according to claim 1 and further comprising:
setting different compiler optimization configurations for any of said entities if a predefined termination condition is not met after performing said compiling step; and
again compiling said computer program in accordance with said compiler optimization configurations, thereby creating another compiled version of said program.

3. A method according to claim 1 and further comprising performing said setting and compiling steps a plurality of times until a predefined termination condition is met.

4. A method according to claim 3 and further comprising determining a fitness level for said compiled program, wherein said predefined termination condition is met when a predefined fitness level is reached.

5. A method according to claim 3 wherein said predefined termination condition is met when said setting and compiling steps are performed a predefined number times.

6. A method according to claim 1 and further comprising performing said setting and compiling steps a plurality of times until for any fitness value that is achieved, no better fitness value is achieved after a predefined number of subsequent iterations.

7. A system for optimizing a computer program, the system comprising:
means for setting a first compiler optimization configuration for a first entity of a computer program, and for setting a second compiler optimization configuration for a second entity of a computer program, wherein said first and second entities are of the same type and wherein said first and second compiler optimization configurations differ; and
a compiler configured to compile said computer program in accordance with said compiler optimization configurations.

8. A system according to claim 7 wherein said compiler includes said means for setting said optimization configurations.

9. A system according to claim 7 wherein
said means for setting is configured to set different compiler optimization configurations for any of said entities if a predefined termination condition is not met after performing said compiling step, and
said compiler is configured to again compile said computer program in accordance with said compiler optimization configurations.

10. A system according to claim 7 wherein said means for setting and said compiler are configured to perform said setting and said compiling a plurality of times until a predefined termination condition is met.

11. A system according to claim 10 and further comprising means for determining a fitness level for said compiled program, wherein said predefined termination condition is met when a predefined fitness level is reached.

12. A system according to claim 10 wherein said predefined termination condition is met when said setting and compiling steps are performed a predefined number times.

13. A system according to claim 7 wherein said means for setting and said compiler are configured to perform said setting and said compiling a plurality of times until for any fitness value that is achieved, no better fitness value is achieved after a predefined number of subsequent iterations.

14. A computer program embodied on a computer-readable medium, the computer program comprising:
a first code segment operative to set a first compiler optimization configuration for a first entity of a computer program, and a second compiler optimization configuration for a second entity of a computer program, wherein said first and second entities are of the same type and wherein said first and second compiler optimization configurations differ; and
a second code segment operative to a compile said computer program in accordance with said compiler optimization configurations.

15. A computer program according to claim 14 wherein
said first code segment is operative to set different compiler optimization configurations for any of said entities if a predefined termination condition is not met after performing said compiling step, and
said second code segment is operative to again compile said computer program in accordance with said compiler optimization configurations.

16. A computer program according to claim 14 wherein said code segments are operative to perform said setting and said compiling a plurality of times until a predefined termination condition is met.

17. A computer program according to claim 16 and further comprising a third code segment operative to determine a fitness level for said compiled program, wherein said predefined termination condition is met when a predefined fitness level is reached.

18. A computer program according to claim 16 wherein said predefined termination condition is met when said setting and compiling steps are performed a predefined number times.

19. A computer program according to claim 14 wherein said code segments are configured to perform said setting and said compiling a plurality of times until for any fitness value that is achieved, no better fitness value is achieved after a predefined number of subsequent iterations.
